(19) United States
(12) Patent Application Publication
(10) Pub. No.: US 2005/0067441 A1
(43) Pub. Date: Mar. 31, 2005

(54) Flexible gate restrictor membrane apparatus

(76) Inventor: Kenneth A. Alley, Tampa, FL (US)

Correspondence Address: LAW OFFICES OF MARK A. GARZIA, P.C., 2058 CHICHESTER AVE, BOOTHWYN, PA, 19061, US

(21) Appl. No.: 10/953,007

(22) Filed: Sep. 28, 2004

Related U.S. Application Data
(60) Provisional application No. 60/506,568, filed on Sep. 29, 2003.

(51) Int. Cl. B67D 3/00

(52) U.S. Cl. 222/547; 222/107; 222/564

(57) ABSTRACT

A valve using a flexible membrane integrated into the throat or passageway. The membrane forms a portion of the passageway's sidewall. The membrane is designed to collapse against another portion of the sidewall to restrict flow of product through the passageway, when it is in one position (i.e., its open position) the flexible membrane forms an inconspicuous part of the sidewall (as far as product moving through the passageway) and product can pass through the passageway freely, when it is in a second position (i.e., its closed position), the flexible membrane is collapsed against a rigid or non-movable portion of the sidewall thereby preventing flow of the product through the passageway.

### CROSS REFERENCE TO RELATED APPLICATIONS

The present application claims the benefits under 35 U.S.C. §19(e) of U.S. Provisional Application No. 60/506,568 filed Sep. 29, 2003, titled Flexible Gate Restrictor Container System in the name of Kenneth A. Alley.

U.S. Provisional Application No. 60/506,568 filed Sep. 29, 2003, is hereby incorporated by reference as if fully set forth herein.

### FIELD OF THE INVENTION

The present invention relates generally to devices for controlling fluid flow from a bottle or other fluid containers. More specifically, this invention relates to a flexible gate system adapted to a container for restricting fluid flow through an upper container port when the container is inverted and/or for controlling general access to the contents of a fluidic or non-fluidic container by means of flexing the gate mechanism.

### BACKGROUND OF THE INVENTION

Alternative systems have been developed to address this problem with water coolers and other fluid containers. U.S. Pat. No. 4,741,448 and U.S. Pat. No. 5,996,860, issued to Kenneth A. Alley, provided solutions to these problems. In the systems taught by the aforementioned patents, a momentary gate was provided for fluid containers that effectively restricted fluid flow through an upper container port as the container was inverted. The momentary gate was incorporated into a fluid container including a bottle having a tapered fluid port at an upper end through which fluid passed to fill or empty the container, and means within the bottle for momentarily restricting fluid flow out of the port when the bottle was inverted. The restricting means taught by the Alley patents had a construction such that if the bottle was filled with fluid in an upright position, the fluid was permitted free passage through the port until the bottle was substantially full if the restricting means was in the bottle during filling, although it was preferred that the bottle be filled without the restricting means. This method required the addition of a separate buoyant capsule which added to the final cost of the product container.

There are also other specialized two-piece closures to control access to the contents of a container, for instance typical shampoo closures. Most of these require more than one component and are therefore cost prohibitive. They also all require a specialized closure. The ideal solution for cost competitive product containers (oil etc.) would be one that would involve no additional components.

### SUMMARY OF THE INVENTION

The present invention is a specialized container comprising a flexible gate system integrated into a container for restricting (or controlling) fluid flow (or access) through an upper container port when the container is inverted.

The subject invention provides a one-piece container system with a built-in flexible gate restrictor. The present invention will also work with standard closures. The flexible gate restrictor may be built directly into the container, thus not requiring a special closure.

The flexible gate membrane may also provide means for tamper evidence, without the need for a tamper evident closure. The adaptation of the flexible gate restrictor membrane provides the means to isolate containers contents with or without the additional cost of a closure. It also provides the means to isolate individual chambers within a single container system. There are numerous applications for the flexible gate restrictor membrane technology.

Numerous fluid containers require careful control of the fluid flow as they are dispensed into their desired reservoir. Additionally, control of oil (anti-freeze, hydrocarbons, chemicals, etc.) flowing from oil containers into gasoline engines are a very common problem. There are many automotive, marine and chemical products that may pose serious safety hazards, environmental hazards and property damage if the fluid spills during dispensing. Funnels may help provide means to carefully dispense the product; however, residue remains on the funnel and it then becomes a hazard as well.

Accordingly, there is a need for a device capable of restricting flow out of water bottles, oil containers, or other fluid and non-fluid containers when they are inverted which would not interfere with normal flow of the fluid (or non-fluid) out of the container after the container was securely positioned where intended. Furthermore, such a flow restriction device was required to have characteristics that permitted control of the outlet port restrictor. Additionally, a flow restriction device for use specifically with oil or other fluid containers is needed that can be adapted for use with existing receiving means, for example engines, reservoirs, etc.

In order to be useful, the restriction device was required to involve minimal expense for manufacturing, must be easy to fill and would ideally be designed to work within current filling, manufacturing and assembly infrastructures.

The present invention consists of a fluid reservoir/container and a specialized flexible gate restrictor built into the bottle neck. The flexible gate restrictor is designed to have a collapsible diameter/geometry with respect to the bottle neck's exit port. The flexible gate restrictor provides the means to occlude the container's exit port.

When the flexible gate restrictor is pushed or snapped inward the bottleneck exit port will be occluded. When the flexible gate restrictor is pulled outward the bottleneck exit port is opened to allow fluidic or non-fluidic product to flow through not restricted.

Unlike other oil containers the present invention would not require the use of a funnel and will provide an economical, simple and safe means to invert the container into its desired location without spilling its contents. That is, the oil container may be partially or completely inverted while the exit port is occluded, and at the designed time the exit port can be opened by operating the flexible gate restrictor.

The present invention also provides restricting means that are built into the container during its molding and or manufacturing process minimizing additional expenses. The present invention becomes a closed loop living hinge thus, no extra components are necessary. The flexible gate may be designed to have numerous geometries and may be designed to open and close by numerous means such as a pull tab or ring; in this particular case the flexible gate restrictor will be either open or closed depending on its static position.

A flexible gate restrictor could be designed to always be in either an open or closed position thus requiring an additional and constant outside force to open or close the flexible gate restrictor (container). One method of doing this would be to manufacture the flexible gate restrictor so that there is a constant force on the restrictor thereby keeping it either always open or always closed when there is no force applied to the pull tab. For example, if the flexible gate restrictor is always closed, a person can open the restrictor by pulling on the pull tab; however, once the person releases the pull tab, the restrictor reverts back to the closed position.

The present invention may require parison profiling during the extrusion blow molding process. The bottleneck portion and flexible gate restrictor section of the parison would require unique tolerances and dimensional geometry in order for the material/plastic to provide the desired features after molding. This geometry requires various container wall thicknesses and wall weights. If the manufacturing process included injection blow molding, stretch blow, (or injection molding) these required tolerances could be built into the injection and blow molds. In the case of extrusion blow (or form fill and seal technology) molding, the existing extrusion molding equipment is capable of providing control of the wall weights in the vertical direction along the parison, for example a control pin will move up or down inside of a tapered extrusion die controlling the thickness of the parison wall along the vertical direction (Y-plane).

Although, the current technology will allow perpendicular control of the parison wall weight the existing technology does not allow means to mechanically control the circumferential (X-Plane) wall weight of a parison along the perpendicular at any given point.

The subject invention also teaches in this invention that the extrusion molding machinery may be adapted to move the control pin either to the left or right or more specifically in the entire X-plane to provide the means to control wall weights at any side of the parison along the perpendicular. Also the subject invention teaches that it may be desired to split the control pin perpendicularly into controlled segments (as many as desired) so that the different sections/segments of the die pin can move up or down independent of the other sections. This improvement will allow very specific wall weight distribution control anywhere along the perpendicular and in many cases would be better than just moving the pin left or right (x plane). This will be illustrated in FIG. 16.

The present invention also teaches that alternative to splitting the extrusion pin would be to split the extrusion die perpendicularly into controlled segments (as many as desired) so that the different sections/segments of the die can move up or down (relative to a fixed pin) independent of the other sections. This particular alternative may be easier to retrofit existing machines because the die is on the outside of the pin and therefore provides easier access to add such a control features.

Although, the previously mentioned invention focuses on fluid containers, the present invention could be used for food and beverage containers, lyophilizing container systems, prescription containers, child resistant containers and many other applications where a flexible gate restrictor could be adapted to everyday fluid or non-fluidic containers. All of these containers may also use the flexible gate restrictor for the sole purposes of a tamper evident membrane thus, eliminating the need for a more expensive tamper evident closure. The flexible gate restrictor could also be adapted to containers, as a splash proof or spill guard, to provide additional safety features.

There are several containers on the market that require special (CRC) child resistant closures. The present invention could be an alternative to the CRC closure whereby, the present invention provides a child resistant container. A container with the flexible gate restrictor System adapted could be designed to work with either a standard closure or by incorporating a CRC feature within the flexible gate membrane to create a child resistant container without the need for a (CRC) closure. The flexible gate membrane could be used to replace the standard closure of many containers and or replace the tamper evident features on closures.

Although the invention description focuses on a fluidic container, thus controlling the flow as the container is inverted; there are numerous container applications that are used for everyday food and beverage packaging, drug and pharmaceutical packaging and chemical packaging that could benefit from the present invention functionally from a cost perspective and from a safety perspective. The present invention will be further described in connection with specific applications to provide the larger scope of this novel invention and technology. Some embodiments include a single piece lyophilization baby bottle, standard lyophilization containers, water/beverage/food container with built in closure/reseal-able features, unit dose applicators, and eyedropper bottles with built-in dropper tip, etc. to name a few.

### BRIEF DESCRIPTION OF THE DRAWINGS

The foregoing summary, as well as the following detailed description, may be better understood when read in conjunction with the accompanying drawings, which are incorporated in and form a part of the specification. The drawings serve to explain the principles of the invention and illustrate embodiments of the present invention that are preferred at the time the application was filed. It should be understood however that the invention is not limited to the precise arrangements and instrumentalities shown.

FIG. 1 is an upright side view of a novel fluid container utilizing a flexible gate restrictor in accordance with the present invention.

FIG. 2 is a perspective side view of the flexible gate restrictor which is incorporated into the container shown in FIG. 1.

FIG. 3 is a perspective side view of another embodiment of the flexible gate restrictor showing the use of a lever that keeps the flexible gate restrictor in a normally open position and which requires a constant force to activate the restrictor.

FIG. 4 is a perspective view of another embodiment of the flexible gate restrictor. This embodiment locates the flexible gate restrictor at the uppermost portion (above the screw threads) of the container. This embodiment would be adapted for use with child resistant containers and may be adapted for use with dry powder or pills.

FIG. 5 is a perspective top view of a different configuration of a flexible gate restrictor which could be adapted to a container.

FIG. 6 is an expanded view of the flexible gate restrictor shown in the closed position.

FIG. 7 an alternative embodiment of the flexible gate restrictor that may be adapted to catheter tubing or other applications where a check valve may be incorporated into the tubing.

FIG. 8 is another embodiment of a flexible gate restrictor membrane. In this particular configuration the flexible gate restrictor membrane is located at the uppermost section of the container, replacing the need for a separate closure.

FIG. 9 is another embodiment of a flexible gate restrictor membrane illustrating tamper evident and child resistant means which are manufactured as part of the flexible gate restrictor membrane technology.

FIG. 10 is another configuration of a flexible gate restrictor membrane. In this particular configuration the flex gate restrictor membrane is designed to function as a controlled dropper tip.

FIG. 11 is another container configuration where the flexible gate restrictor membrane is located at the uppermost section of the container, replacing the need for a separate closure.

FIG. 12 represents a perspective side view of an applicator device with the flexible gate restrictor membrane technology.

FIG. 13 is a perspective isometric view of a multiple chambered baby bottle. This particular baby bottle has the flexible gate restrictor membrane incorporated between two separate chambers of the container. This particular application will provide an economically feasible single-piece lypholization container for mixing liquids and or powders or a combination of substances.

FIGS. 14 and 15 illustrate additional embodiments of the flexible gate restrictor membranes integrated into various containers.

FIG. 16A is a prior art die.

FIGS. 16B and 16C illustrates two novel pin-die apparatus that can be used to manufacture a passageway having variable thickness sidewalls. The pin-die apparatus controls the wall weight of the parison during the extrusion molding process. By incorporating this technology waste material (plastic resin) could be minimized and design detail and product design capability could be substantially improved.

### DETAILED DESCRIPTION OF THE PREFERRED EMBODIMENT

Referring now to FIG. 1, container 10 for controlling fluid flow especially when a container is inverted is shown. Container 10 consists of a flexible gate system 20 adapted to container 10 for restricting fluid flow through an upper container port 13 when the container is inverted.

Container 10 would be molded with the flexible gate system 20 in the open position shown in FIG. 1. The membrane 23 of flexible gate restrictor 20 does not interfere (in the open position) with the filling of container 10. In the open position, entry/exit port 13 has an uninterrupted passage way to reservoir 11. (Of course, if the restrictor gate is manufactured to be “always closed”, and there is no external force, a filling tube may be inserted into the neck of the container, gently opening the restrictor in order to allow the container to be filled. When the tube is removed, the restrictor closes.)

Once container 10 is filled, flexible gate restrictor 20 may be closed by applying a force onto membrane 23. When membrane 23 of flexible gate restrictor 20 is pushed inward, the inner wall of membrane 23 is moved against the inner wall of the neck's sidewall opposite to the restrictor and forms a restricted passageway between entry/exit port 13 and reservoir 11. Specifically, the diameter of inner bottleneck 25 is effectively reduced to zero when the restrictor membrane 23 frictionally mates with the inner wall of the bottle neck 25, thus creating a restricted passageway between container reservoir 11 and the entry/exit port 13. A standard closure or lid (not shown) may then be applied to threads 17 and snapped over tamper proof bead 19 of container 10. Of course, a foil seal may also be used to cover the exit port 13 to provide evidence of tampering. Further, the membrane 23 may be ultrasonically sealed to the bottle neck's inner sidewall which would also provide a tamper evident closure.

Container 10 with the flexible gate restrictor 20 (when in the closed position) would then be ready for packaging and shipping of reservoir 11. The contents can be emptied, for example, the user may hold container by finger grips 15 (not necessary), invert the container 10 and pull the restrictor away from the neck's sidewall allowing the product in the reservoir 11 to empty out.

When the entry/exit port 13 of container 10 is safety oriented into the desired position, pull tab 21 may be utilized to retract/open membrane 23 of flexible gate restrictor 20, thus providing an unobstructed passageway between the reservoir 11 and entry/exit port 13 of container 10. (A rapid compression or squeezing of the container may also activate the flexible gate restrictor which would force product between the membrane 23 and the neck's sidewall thereby forcing the restrictor into the open position.)

It may be desired to keep membrane 23 open and let the end user decide if they wish to close off membrane 23 and aseptically seal the container. This embodiment could replace the need for a tamper evident cap.

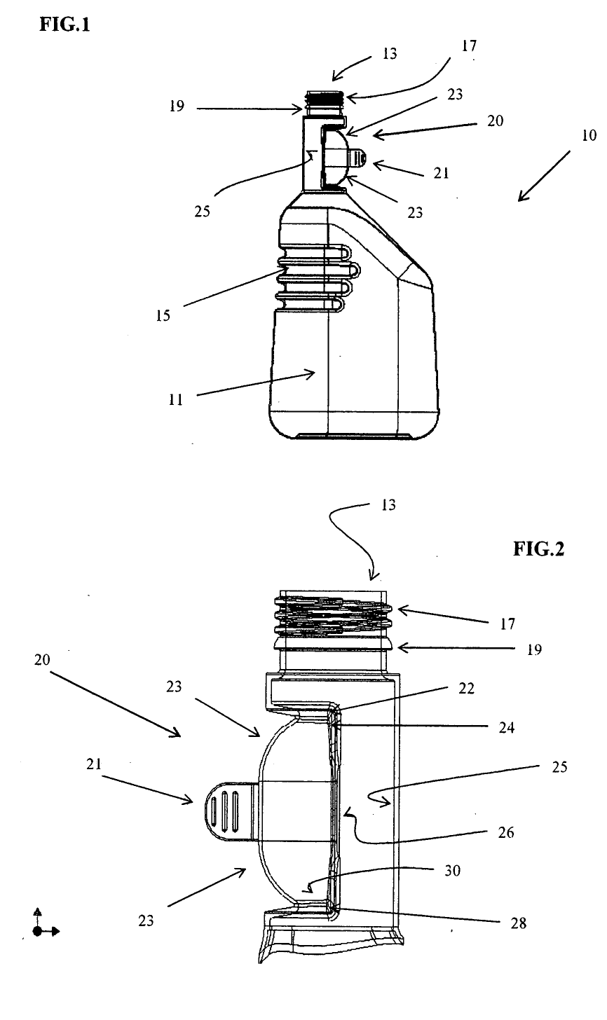

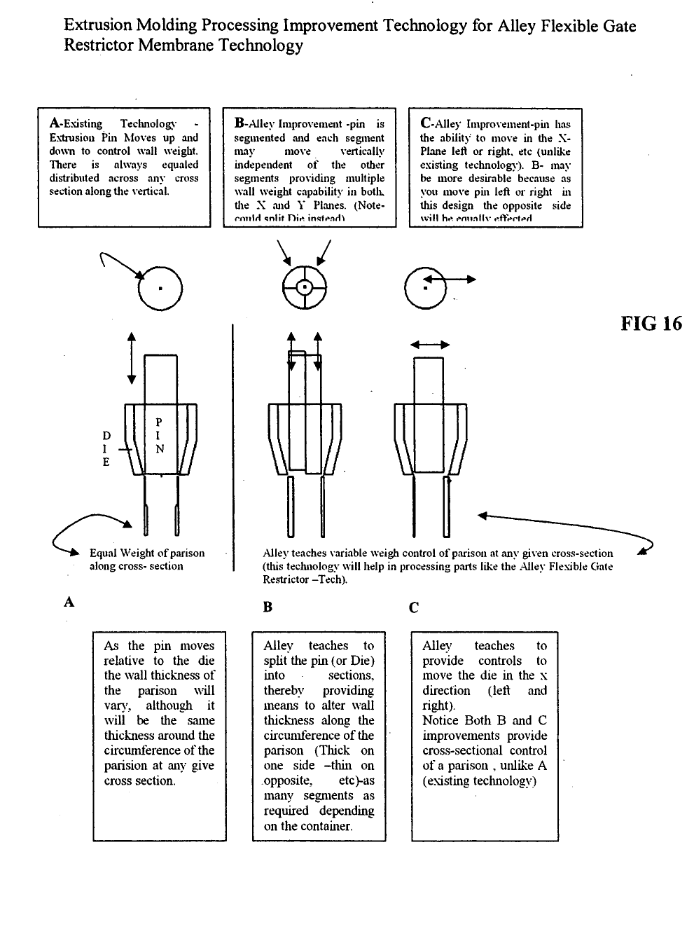

FIG. 2 is an expanded view of the flexible gate restrictor 20, incorporated into container 10 shown in FIG. 1. Flexible restrictor gate 20 is shown in the open position which allows product to pass into or out of the reservoir 11. Membrane 23 has unique and controlled wall weight distributions/dimensional tolerances 22, 24, 26, 28, and 30. In the preferred manufacturing process (extrusion blow molding) these tolerances will be controlled by profiling the parison, (available with more modern material weight distribution and temperature control systems). Although, the subject invention teaches improvements to the existing technology as explained hereafter and illustrated in FIG. 16.

When membrane 23 of flexible gate restrictor 20 is pushed inward, the inner bottleneck sidewall 25 frictionally engages with the inner sidewall of membrane 23, thus creating a restricted (controlled) passageway between container reservoir 11 and the entry/exit port 13. The frictional mate quality between inner diameter 25 and membrane 23 is enhanced by the nature of the plastic and the controlled wall weight distribution. Plastic distribution in specific areas 22, 24 28 and 30, help provide an increased frictional pressure at sealing surface 26. This configuration provides a closed loop living hinge built within the container. Additionally, this sealing surface may be ultrasonically sealed to provide an aseptic liquid seal, or other means may be adapted to create a tamper evident or liquid seal, including co-extrusion materials, adhesives or induction technologies for an example.

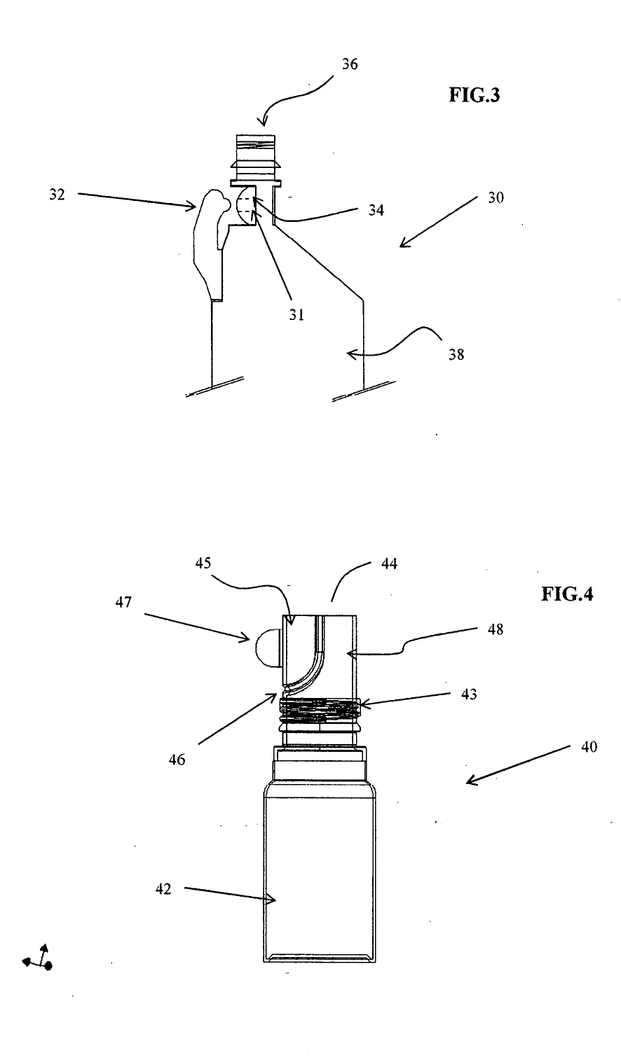

Referring now to FIG. 3, an alternative embodiment is illustrated. Container 30 is adapted with a modified flexible gate restrictor 34. This embodiment would require a constant force to activate (i.e., close) the flexible gate restrictor 34 and to maintain a restricted passageway. The membrane 31 is designed to stay in the open position unless a constant force is applied. Lever 32 of container 30 provides the force to close the membrane 31 of flexible restrictor gate 30. In this configuration, lever 32 will be compressed against membrane 31, thus, occluding the passageway between entry/exit port 36 and reservoir 38. When the entry/exit port 36 of container 30 is safety oriented into the desired position, lever 32 will naturally swing outward, simultaneously, membrane 31 will return to its static state (open position) of the flexible gate restrictor 34, thus providing an unobstructed passageway between the reservoir 38 and entry/exit port 36 of container 30. Lever 32 could be eliminated and an enduser may use his thumb, by squeezing the flexible gate restrictor and after releasing it, the flexible gate restrictor would pop back open. In a variation of the embodiment illustrated in FIG. 3, the lever 32 may be physically connected to the membrane 31 and the lever 32 provides the force to keep the restrictor open.

Referring now to FIG. 4, an alternative embodiment of a container with a flexible gate restrictor is shown. This embodiment locates the flexible gate restrictor at the uppermost portion (above the screw threads) of the container. This embodiment would be adapted for use with child resistant containers and may be adapted for use with dry powder or pills.

Container 40 consists of reservoir 42, pulltab 47 and flexible gate restrictor 45. Container 40 is shown with the flexible gate restrictor 45 in the open position. Living hinge 46 provides the means to collapse the flexible restrictor gate 45 inward towards the inner sidewall 48 of exit/entry port 44. This configuration could utilize a specially designed closure or cap to attach to the threads 43 of container 40.

FIG. 5 is a perspective top view of another embodiment of a flexible gate restrictor 50, which could be adapted to a container.

Flexible gate restrictor 50 is shown in the closed position. As previously mentioned specific wall weight distribution will help to create living hinges 51, 52 and 56 thus, providing the means to flex membrane 57 inward towards inner sidewall 54 of flexible gate restrictor 50. In this position the exit/entry port would be occluded.

It should be noted that pull tab 53 could be made longer, then flexed to either side and snapped into locking features (not shown) which could be located on the outer diameter of hinges 51, thus catching the tab 53 and holding flexible gate restrictor membrane closed. This feature could be used for tamper evidence and/or child resistance features.

Referring now to FIG. 6, an expanded view of the flexible gate restrictor 20, which can be adapted to a number of different containers is shown. Flexible restrictor gate 20 is shown in the closed position. Depending on the particular application, the flexible gate may be frictionally sealed or mechanically sealed. In the oil container application it may be desired to leave the gate open and let the end user decide whether or not they wish to use the gate restrictor. If the flexible gate restrictor is sealed (for example, ultrasonically) after the container is filled, it will provide both tamper evidence and flow control means, thus, providing cost savings by eliminating the need for more expensive tamper evident closures.

When membrane 23 of flexible gate restrictor 20 is pushed inward, the inner bottleneck sidewall 25 frictionally mates with the inner wall of membrane 23, thus creating a restricted (controlled) passageway between container reservoir 11 and the entry/exit port 13.

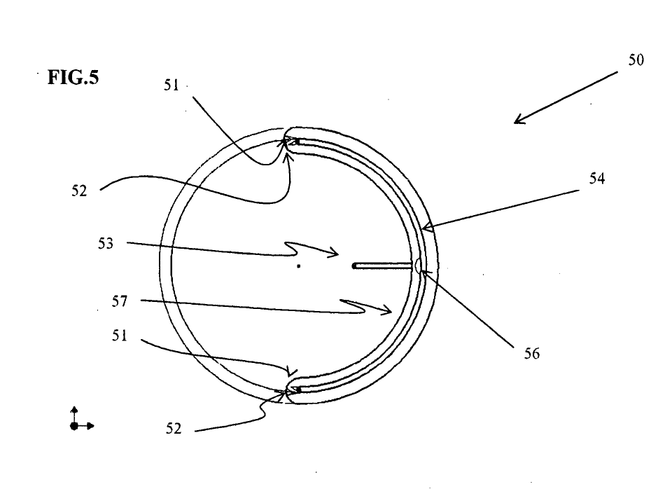

Referring to FIG. 7, an alternative embodiment of the flexible gate restrictor is illustrated that may be adapted to catheter tubing or other applications where a check valve may be incorporated into the tubing. For example, infections can occur when waste fluid backflows up through catheter tubing and into the patient's bladder. There are also numerous other applications where this alternative flexible gate restrictor may be adapted.

Referring to FIG. 8, another configuration of a flexible gate restrictor (neck finish) 80 is illustrated. In this particular configuration, the flexible gate restrictor 80 is located at the uppermost section of the container, replacing the need for a separate closure. Flexible gate restrictor 80 would be molded as part of the container in the open position. This particular configuration has flexible membrane 23, pull tab 21 and one or more sealing undercuts 81. The undercuts 81 would provide a seal when the flexible membrane 23 is closed and inserted under the undercuts 81. This particular seal would be adequate for liquids, powders, pills etc.

The flexible gate restrictor membrane 80 replaces the need for a typical closure. The sealing undercuts 81 are designed to close off the container contents whenever the flexible membrane 23 is pushed inward. If desired, an inexpensive over cap may be applied to cover the flexible gate restrictor or to add additional features, such as tamper evidence or child resistance capabilities. As in the other configurations of the flexible gate restrictor, it may be desired to use ultrasonic, induction or adhesives to aseptically seal the contents for tamper evidence means or (lyopholization) which is more fully described herein in connection with FIGS. 12 through 15. Flexible gate restrictor 80 would be ideal for food, and beverage and pharmaceutical containers. If undercuts 81 are not incorporated, the flexible gate restrictor membrane would rely on the frictional engagement between the interior wall of the container and of the flexible membrane 23 to provide a quality sealing surface.

FIG. 9 illustrates an embodiment that may be used with prescription-type vials 90. The membrane 23 would be molded in the open position, then pull/push tab 21 is pushed inwards to close off the exit port of the vial. An extended lip 91 has a tamper evident slot 92.

When the membrane is closed, lip 91 is folded over the membrane and push tab 21 is inserted through slot 92. The tab 21 can then be folded left or right to prevent the lip 91 from popping open. Alternatively, the lip 91 can be sealed in this position overlapping the membrane 23.

There are numerous configurations and designs that could be adapted to provide a CRC (child resistant closure) and tamper evident features which are built into the flexible gate restrictor Membrane Technology. Depending on the individual application an additional over-cap may be applied to help add these features as well.

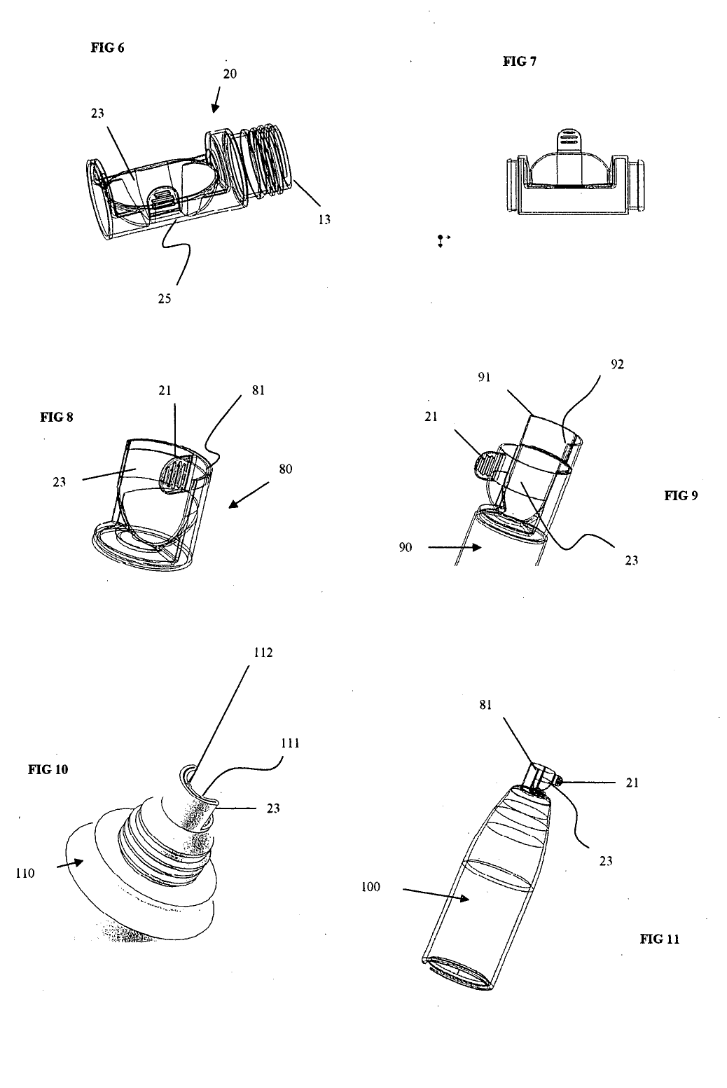

Referring now to FIG. 10, another configuration of a flexible gate restrictor membrane molded as part of a container 110 is illustrated. In this particular configuration, the flex gate restrictor membrane 23 is designed to function as a controlled dropper tip.

There are numerous applications where dropper tips are attached to containers for the purpose of dispensing one drop (or controlled portion) of the containers contents at a time. Most commonly are eye dropper containers. Other applications include paints, liquid candies, etc.

If and when a dropper tip is required, the manufacturer must not only purchase the expensive tips, they must also have specialized equipment to insert or attach them to the container. The extra component along with the additional manufacturing process and equipment adds substantial cost to the overall product. Additionally, in many cases there is a hazard that the tip may fall out creating a danger to small children. This particular application incorporates the dropper tip means as part of the container 110. There is no need to purchase a separate components (dropper tip) or special assembly equipment. The dropper tip feature may be incorporated as part of the flexible gate restrictor membrane and therefore cannot be removed or fall out of the container.

For example, container 110 will be molded with the flexible gate restrictor in the open position, thus membrane 23 will be in the open position. In this particular configuration, membrane 23 does not require a pull tab 21 as previously described. Container 110 will be filled with a liquid solution and afterwards, membrane 23 will be pushed inward (permanently), thus forming a controlled dropper tip 111. Controlled dropper tip 111 includes an orifice 112 that extends the entire length of the membrane 23 and will provide the means to dispense the solution when the container is inverted. Orifice opening 112 of container 111 is made to a pre-determined diameter and will provide means to control the flow/dispensing of the containers contents. A special closure (not shown) can be adapted so the landing area of the interior of the cap mates with the sealing surface of the dropper tip.

FIG. 11 is another container configuration where the flexible gate restrictor membrane is located at the uppermost section of the container, replacing the need for a separate closure. This particular container 100 could be used as a water, or food and beverage container. Flexible membrane 23 will open and close the container. A special sealing bead 81 may be incorporated to provide a liquid tight seal when the flexible gate restrictor membrane is in the closed position. An over-cap (not shown) could be adapted to frictionally engage flexible membrane 23 to enhance the sealing quality or to provide tamper evident features. Container 100 would be a very economic food and beverage container. The elimination of the screw threaded cap would be a major cost savings.

Now referring to FIG. 12, a perspective side view of an applicator device 200 that utilizes the flexible gate restrictor membrane technology is disclosed herein.

There are numerous applicators on the market; most commonly they require a sealed plastic housing (or container) around a breakable glass ampule. To activate the system the plastic housing is bent, thus breaking the ampule. The prior applicators require multiple parts and specialized equipment to make and fill the ampule.

In FIG. 12, applicator 200 includes liquid chamber 202 and applicator head 201. Flexible gate restrictor membrane 20 is aseptically sealed after chamber 202 is filled. In order to activate the applicator, tab 21 is pulled outward breaking the aseptic seal, thus, allowing liquid to flow into applicator head. There is no need for additional parts or glass ampules. The applicator may be sealed by ultrasonically sealing the flexible membrane just enough that sufficient outward force will break the seal. Alternatively, adhesives, induction sealing and or a combination of these or similar technologies may be adapted to seal the chamber. The application head 21 may be made of cotton, or any of the normal absorbent materials applicators typically utilize.

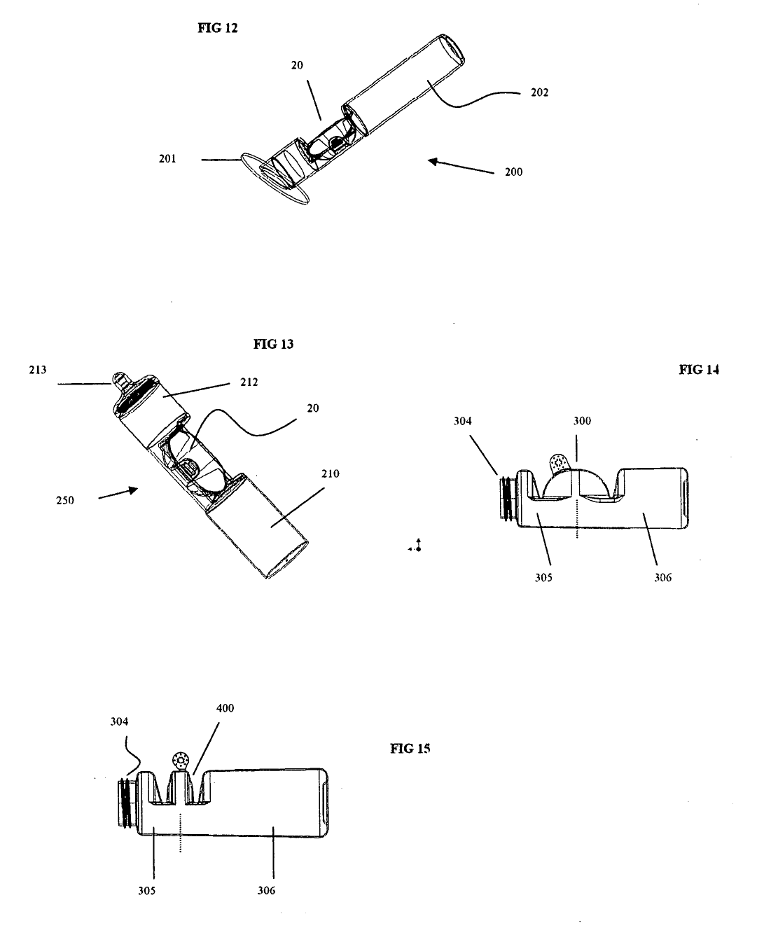

FIG. 13 is a perspective isometric view of a multiple chambered baby bottle. This particular baby bottle has the flexible gate restrictor membrane incorporated between two separate chambers of the bottle. This particular application will provide an economically feasible single piece lyopholization container for mixing liquids and or powders or a combination of substances. There are numerous applications for lyopholization containers; these include light sticks, pharmaceuticals, premix drinks, baby formulas etc. One thing they all have in common with their design is that the mechanisms used to isolate the various substances include separate containers that are either broken or pierced in order to mix the substances. They all include multiple containers, ampules or vessels, etc. In some cases, the expense of the extra components will outweigh the benefits of the application.

In FIG. 13, this particular baby bottle has the flexible gate restrictor membrane incorporated between two separate chambers of the container. It utilizes two containers to provide the means to isolate, and then mix substances at a desired time. For example, baby bottle 250 would be molded with the flexible gate restrictor 20 in the open position. Chamber section 210 of baby bottle 250 would then be filled with a liquid (water), a mechanical arm will push inward and heat seal (aseptically seal) flexible gate restrictor 20 in the closed position thus, isolating chamber 210 from upper chamber 212. Further down the filling line a powdered baby formula, pill or nutritional substance will be placed into upper chamber 212 and finally baby bottle nipple 213 (or other suitable cap) will be placed on to container 250. This particular configuration could be used as a single-use humanitarian baby bottle that could be shipped all over the world without refrigeration. Alternative systems would require separate containers and or components including clean water to mix substances. This could also serve as an economical single-use instant nutrient container for everyday applications. (Although, this particular example includes only two different chambers it would be possible to add as many chambers as necessary each separated by a gate restrictor for the particular application.)

FIGS. 14 and 15 represent alternative containers with differently designed flexible gate restrictor membranes 300 and 400 respectively. These containers also include chambers 305 and 306 that are also isolated when either flexible gate restrictor membranes 300 or 400 are closed. The screw threaded finish 304 could be designed to accept a baby bottle nipple, regular bottle cap, spout cap (water) or any closure, again depending on the application.

FIGS. 14 and 15 could be used to hold chemicals, pharmaceuticals and or foods and beverages. For example, water and powdered milk/chocolate may be isolated and un-refigerated until ready for use. Water and nutrient drinks may be isolated thus, enhancing product shelf life. Just prior to use the restrictor membranes may be unsealed and the products could then be mixed activating the active substances. There are numerous uses for such a novel container system that range from cosmetic to pharmaceutical applications to foods. The purpose of the described examples is to show the wide scope of the novel flexible gate restrictor membrane technology and not to limit this technology to these particular examples. The economic impact of eliminating the need for tamper evident closures or even any closure could have a very positive effect on cost, environment and product designs of the future.

FIG. 16A is a representation of existing technology to control the wall thickness-weight of a parison. The extrusion pin moves either up or down relative to the die. This widens and tightens the opening between the pin and die thus, controlling the wall thickness of the parison. This technology is limited in the fact that the wall weight will be equally distributed around the circumference of the parison at any given cross-section. Therefore, during processing it is necessary to use heat and cutouts to remove excess material, thus limiting the overall capability of the extrusion molding technology. For example, to manufacture the flexible gate restrictor membrane, we need to have a relatively heavy thick wall on the opposite side of the membrane to support the neck of the container (loading purposes, etc.). On the membrane side there is a substantially thinner wall which allows movement of the membrane relative to the opposing sidewall. Most commonly there will be a cutout (material waste) on the light weight side in order to manufacture both extreme wall weight distributions at the cross-section.

Referring to FIGS. 16B and 16C, the present invention teaches and alternative method to control the wall weight distribution along the parison circumferentially at any given cross section. Therefore, on one side of the parison there could be a thin extruded wall thickness-weight and at the same (cross-section) y-position there could be a heavy wall thickness-weight distribution.

In FIG. 16B, the pin is divided into one or more segments. The segments may be equally-sized or of different sizes depending on the application. The extrusion pin is segmented and each segment may move vertically independent of the other segments providing multiple wall weight capability in both, the X and Y planes. The present invention teaches to split the pin into (two or more) sections, thereby providing means to alter wall thickness along the circumference of the parison (thick on one side-thin on opposite, etc.) and utilize as many segments as required depending on the container.

In FIG. 16C the extrusion pin has the control capability of moving to the left or right (X-Plane) also providing means to alter wall weight along the cross-section, although in the approach when moving the pin in any left or right direction the opposite side will be altered as well. The approach in FIG. 16B will provide the most flexibility to the extrusion process and provide much greater control allowing for more complex product designs and simultaneously eliminating resin (material) waste compared to existing extrusion molding technology.

Additionally, the present invention also teaches an alternative to splitting the extrusion pin (as in FIG. 16B). In an alternate embodiment, the extrusion die would be split perpendicularly into controlled segments (as many as desired) so that the different sections/segments of the die can move up or down (relative to a fixed pin) independent of the other die sections. This particular alternative may be easier to retrofit existing machines because the die is on the outside of the pin and therefore provides easier access to add such control features.

Although this invention has been described and illustrated by reference to specific embodiments, it will be apparent to those skilled in the art that various changes and modifications may be made which clearly fall within the scope of this invention. The present invention is intended to be protected broadly within the spirit and scope of the appended claims.

1. A valve for use with a container, the container having an outlet, the outlet including a passageway through which product passes when the container is being filled or emptied, said valve comprising:
a flexible restrictor integrated into a sidewall of the passageway, said restrictor being movable with respect to an opposite sidewall of the passageway thereby closing and opening the passageway so that, when the restrictor is moved against the opposite sidewall, the restrictor is in its closed position and product is prevented from entering or exiting the container, and when the restrictor is moved away from the opposite sidewall, the restrictor is in its open position and product can enter or exit the container.

2. The valve of claim 1 further comprising a means attached to said flexible restrictor that facilitates the operation of said restrictor so that an entity (e.g., a person or machine) can move said restrictor with respect to the opposite sidewall.

3. The valve of claim 2 wherein said means that facilitates the operation is a pulltab.

4. The valve of claim 1 further comprising means to indicate evidence of tampering.

5. The valve of claim 4 wherein said tamper evidence means comprises an overcap that is sealed to the passageway, said overcap preventing product from entering or exiting the container regardless of the position of the restrictor.

6. The valve of claim 5 wherein the overcap is sealed to the passageway by an adhesive.

7. The valve of claim 4 wherein said tamper evidence means comprises ultrasonically sealing the restrictor to the opposite sidewall when the restrictor is in its closed position.

8. The valve of claim 1 further comprising a cap having threads on its interior surface and wherein the outer surface of the passageway includes threads that mate with said threads in the cap allowing said cap to screw onto the container.

9. The valve of claim 1 further comprising a dropper tip integrated into the passageway for providing a means of controlling the flow out of the container when the restrictor is in its closed position.

10. The valve of claim 1 further comprising means for keeping the restrictor in the always closed position unless a continuous force is used to move the restrictor to the open position.

11. The valve of claim 1 further comprising means for keeping the restrictor in the always opened position unless continuous force is used to move the restrictor to the closed position.

12. The valve of claim 11 wherein said means for keeping the restrictor in the “always open” position comprises a lever, the lever has a first end attached to the outside of the container and a second end attached to the outer surface of the restrictor, said lever pivots about its first end and in its rest position holds the restrictor in its open position;
the lever being manipulable so that a force applied to the lever will move the restrictor from the open position to its closed position.

13. A removable valve for use with a container, tubing or other apparatus which requires control of liquid passing therethrough, said removable valve comprising:
an elongated passageway having a first end and a second end, the first end of the passageway having a means that mates with the opening of the container (or tubing) so that the valve can be releasbly attached to the opening of the container; and
a flexible restrictor integrated into the sidewall of said passageway and forming a part of said passageway, said restrictor being movable with respect to at least a portion of the sidewall of the passageway generally opposite to the restrictor, thereby opening and closing said passageway.

14. A dropper tip designed to be used with a container storing a liquid, the container having an open end to which the dropper tip is attached, the dropper tip controls the output of the liquid through the tip based generally on the pressure applied to the outside of said container, said dropper tip comprising:
a tubular portion forming a passageway;
a flexible restrictor integrated into a sidewall of the tubular portion, said restrictor being movable with respect to an opposing sidewall of the tubular portion thereby closing and opening the passageway so that when the restrictor is in a first position furthest away from the opposing sidewall liquid can pass freely through the passageway and the container may be filled, and when the restrictor is moved against the opposing sidewall the restrictor is in its substantially closed position;
said tubular portion being adapted to be attached to the container when the restrictor is in the open position to facilitate the filling of the container, and when the restrictor is in the closed position, a pre-determined-sized hole is formed between the restrictor and the opposing sidewall, said pre-determined-sized hole forming the dropper tip which allows liquid to pass therethrough upon squeezing of said container.

15. The dropper tip of claim 14 wherein the restrictor is permanently sealed to the opposite sidewall except for said pre-determined-sized opening.

16. An applicator comprising:
an elongated container having a neck portion for allowing a product to pass therethrough, said container also serving as a handle;
a flexible restrictor integrated into a sidewall of the neck portion, said restrictor being movable with respect to an opposite sidewall of the neck portion thereby closing and opening the passageway so that, when the restrictor is moved against the opposite sidewall, the restrictor is in its closed position and product is prevented from entering or exiting the container, and when the restrictor is moved away from the opposite sidewall, the restrictor is in its open position and product can enter or exit the container;
a pad for delivering the liquid stored in the container to a surface;
a head that is designed to secure the applicator and that communicates with the neck portion for allowing liquid that passes through the restrictor to be delivered to the applicator.

17. The applicator of claim 16 wherein said pad is an absorbent cotton.

18. A dual-compartment container comprising:
a first storage compartment having a closed end and an open end;
a second storage compartment having first and second open ends;
a passageway for connecting the open end of the first storage compartment with the first open end of the second storage compartment, thereby allowing product to pass between the two compartments;
a flexible restrictor integrated into a sidewall of the passageway, said restrictor being movable with respect to an opposite sidewall of the passageway thereby closing and opening the passageway so that, when the restrictor is moved against the opposite sidewall, the restrictor is in its closed position and product is prevented from entering or exiting the first container and which effectively isolates the second container from the first container, and when the restrictor is moved away from the opposite sidewall, the restrictor is in its open position and product can flow between the two containers

19. The dual-compartment container of claim 18 further comprising a means for sealing off the second open end of the second storage compartment.

20. The dual-compartment container of claim 19 further comprising an insert that is sandwiched between the restrictor and works in concert with the restrictor for forming an aseptic seal that can be broken upon the manipulation of said restrictor.

21. The dual-compartment container of claim 19 wherein the second open end of the second storage compartment has threads on its outer surface, and the sealing means is a cap having mating threads thereby allowing said cap to screw onto said second open end.

22. A pin-die mechanism for making a tubular passageway for a plastic parison, the passageway having variable, controlled thickness sidewalls, said die comprising:
a plurality of axial pin sections, said plurality of pin sections forming an inner pin, wherein each pin section can move in the axial direction independent of the other pin sections thereby allowing each pin section to be controlled separately from the other pin sections, so that pin sections on a particular side can be manipulated during the formation of said passageway in a manner that alters the thickness of the passageway's sidewall.

23. The die of claim 22 wherein there are exactly four equally-sized pin sections.

24. The die of claim 22 wherein the pin sections have different shapes and sizes.

25. A pin-die mechanism for making a tubular passageway for a plastic parison for extrusion blow molding, the passageway having variable thickness sidewalls, said die comprising:
an inner pin, wherein said pin can move both in the axial direction and the radial direction, so that the pin can be manipulated during the formation of said passageway in a manner that alters the thickness of the passageway's sidewall.
